(19) United States
(12) Patent Application Publication
(10) Pub. No.: US 2005/0078843 A1
(43) Pub. Date: Apr. 14, 2005

(54) Hearing aid system

(76) Inventor: Natan Bauman, Cheshire, CT (US)

Correspondence Address: CANTOR COLBURN, LLP, 55 GRIFFIN ROAD SOUTH, BLOOMFIELD, CT, 06002, US

(21) Appl. No.: 10/773,731

(22) Filed: Feb. 5, 2004

Related U.S. Application Data
(60) Provisional application No. 60/445,034, filed on Feb. 5, 2003.
(60) Provisional application No. 60/514,994, filed on Oct. 27, 2003.
(60) Provisional application No. 60/535,569, filed on Jan. 9, 2004.

(51) Int. Cl. H04R 25/00

(52) U.S. Cl. 381/312; 381/317; 381/328; 381/324

(57) ABSTRACT

An exemplary hearing aid system includes a receiver configured so as to create an insertion loss over the audible range of hearing below about three decibels as compared to the unaided ear. An exemplary hearing aid system also includes one or more of: a micro-receiver positioned in an open-ear configuration within the ear canal of a user; an intermediate connecting portion extending between a sound processing unit and a receiver, wherein the intermediate connecting portion includes a stiffening wire provided on at least a portion of the intermediate connecting portion and/or within or on at least a portion of the receiver; a retaining wire extending from one of the stiffening wire and the receiver, the retaining wire configured to position within a portion of the concha of the ear; an electrical conducting component comprising two wires within distinct channels or otherwise isolated from one another within the intermediate connecting portion; and a speaker, at least partially enclosed within a casing having first and second end portions, the first end portion communicating with, the connection, the speaker communicating with a port provided at the second end portion of the casing, wherein the casing is sealed to fluids and wherein the port is sealed to fluids by a membrane or mesh material. The described hearing aid reduces the insertion and occlusion effects relative to comparison devices.

### CROSS REFERENCE TO RELATED APPLICATIONS

The present application claims priority to U.S. Provisional Patent Application No. 60/445,034, filed Feb. 5, 2003, U.S. Provisional Patent Application No. 60/514,994, filed Oct. 27, 2003, and U.S. Provisional Patent Application No. 60/535,569, filed Jan. 9, 2004, the entire contents of which are specifically incorporated herein by reference.

### BACKGROUND

A wide variety of hearing aid units are known in the art. Insertion of hearing aid receivers in the ear produces an insertion loss, which reflects a distortion or elimination of the patient's natural or original concha and ear canal resonant characteristics. The presently described hearing aid is configured to eliminate or significantly reduce such insertion losses.

In some hearing aids, the receiver is also positioned within the ear canal in such a way that it creates an occlusion effect. In most cases, whether the hearing aid is fitted in the ear, as with a custom made instrument, or is placed behind the ear, an occlusion problem exists.

This is often related to a patient's rejection of the amplification due to the patient's discomfort with the patient's own voice. That is, the occlusion effect is associated with the sensation or feeling that the patient's head is “at the bottom of the barrel,” with the patient's own voice becoming intolerably loud.

Placing an earmold or a shell of a custom made hearing aid within the ear canal can produce a low frequency amplification of the patient's voice of between about 20 and 30 decibels. This can relate to a perceived loudness increase in the patient's own voice of about four times the actual loudness of the patient's voice.

Accordingly, there remains a need in the art for an ear canal receiver that avoids the insertion loss and occlusion effect problems described above.

One aspect of the present disclosure also relates to an improved system for treating tinnitus.

### SUMMARY

The above-discussed and other drawbacks and deficiencies of the prior art are overcome or alleviated by the presently described hearing aid system, including a receiver configured so as to create an insertion loss over the audible range of hearing below about three decibels as compared to the unaided ear.

In another embodiment, a micro-receiver positioned in an open-ear configuration within the ear canal of a user, and a sound processing unit provided remote from the micro-receiver. The described hearing aid advantageously reduces the insertion and occlusion effects.

In one exemplary embodiment, the receiver has a maximum lateral dimension ø. Such dimension describes the maximum overall dimension or diameter (though it is not to be implied that the cross section of the receiver must be circular or oval) of the receiver. In one exemplary embodiment, the receiver has a dimension ø that is less than half the maximum lateral dimension or diameter of the user's ear canal. In another embodiment, the receiver has a dimension ø that is less than twenty percent of the maximum lateral dimension or diameter of the user's ear canal. In another embodiment, the receiver has a dimension ø that is less than ten percent of the maximum lateral dimension or diameter of the user's ear canal. In another embodiment, the receiver has a dimension ø that is less than five percent of the maximum lateral dimension or diameter of the user's ear canal.

In another exemplary embodiment, the hearing aid comprises a sound processing unit, a receiver, and an intermediate connecting portion between the sound processing unit and the receiver, wherein the intermediate connecting portion comprises an electrical conducting component and a stiffening wire, provided on at least a portion of the intermediate connecting portion. In another exemplary embodiment, the stiffening wire comprises a stainless steel wire. In another exemplary embodiment, the stiffening wire comprises a metal or alloy of metals having memory such that the wire may deflect and return to an original orientation. Such may be stainless steel, among others. Such may also be a shape memory alloy.

In another exemplary embodiment, the stiffening wire is provided within or on a portion of the intermediate connecting portion and extends within or on at least a portion of the receiver. In such embodiment, the receiver is positioned on the intermediate connecting portion with greater stability and resiliency. Also where a stiffening element is used, the intermediate connecting portion and receiver may be custom manufactured or custom molded to optimize positioning of the receiver within the ear canal and/or to optimize positioning of the intermediate connecting portion.

In another embodiment, a retaining wire extends from one of the stiffening wire and the receiver. The retaining wire is configured to position within a portion of the concha of the ear. In such embodiment, the retaining wire may be configured to prevent excessive insertion of the hearing aid receiver into the ear canal. Also, the retaining wire may be configured to cause the hearing aid receiver to be suspended within a portion of the ear canal, such that no portion of the receiver touches the sides of the ear canal.

In another embodiment, the electrical conducting component comprises two wires within distinct channels or otherwise isolated from one another within the intermediate connecting portion. In another embodiment, a stiffening element is provided within or on the intermediate connecting portion within a distinct channel or otherwise isolated from the wires.

In another embodiment, the receiver comprises a speaker, at least partially enclosed within a casing having first and second end portions, the first end portion communicating with the intermediate connecting portion, the speaker communicating with a port provided at the second end portion of the casing. In another embodiment, the casing is sealed to fluids at the first end portion and along a length of the casing extending from the first end portion to the port provided at the second end portion. The port may also be sealed to fluids by a membrane or mesh material.

The above-discussed and other features and advantages of the present invention will be appreciated and understood by those skilled in the art from the following detailed description and drawings.

### BRIEF DESCRIPTION OF THE DRAWINGS

Referring now to the exemplary drawings wherein like elements are numbered alike in the several FIGURES:

FIG. 1 is a diagrammatic view of an exemplary receiver, intermediate connecting portion and sound processing component connector for a hearing aid system;

FIG. 2 is a cross sectional view of an exemplary receiver and intermediate connecting portion;

FIG. 3 is an expanded plan view of an exemplary receiver, intermediate connecting portion and sound processing component connector for a hearing aid system;

FIG. 4 is a plan view of an exemplary assembled hearing aid system including a retaining wire;

FIG. 5 is a cutaway view of a user's ear with the hearing aid system installed;

FIG. 6 is a plan view of an exemplary sound processing unit; and

FIG. 7 is a plan view of another exemplary sound processing unit.

### DETAILED DESCRIPTION

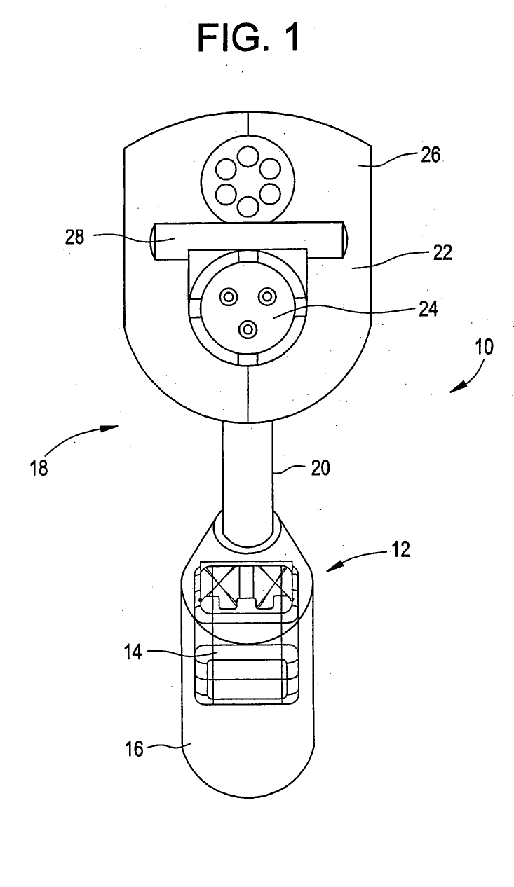

Referring now to FIG. 1, an exemplary receiver and connection portion is illustrated generally at 10 for the presently described hearing aid system. In one exemplary embodiment, the hearing aid system is configured as a completely open canal (COC) system. With reference to FIG. 1, the illustrated exemplary receiver portion, shown generally at 12, includes a speaker 14 that is at least partially surrounded by a casing 16. The receiver portion 12 is attached to a connection portion, shown generally at 18, which includes an intermediate connecting portion 20 and a sound processing component connector 22. The sound processing unit connector 22 includes an electrical interface 24 configured to mate with a corresponding electrical interface (not illustrated) on the sound processing unit. The illustrated electrical interface 24 is a three-pin female interface, surrounded by a connector shell 26. While shell 26 is illustrated as a two part shell joined by lock pin 28, it should be recognized that shell 26 may take any convenient configuration, or the interface 24 may simply comprise the electrical interface 24 such that the shell 26 is of minimal profile or is eliminated. Optionally, a microphone 27 may be provided in the shell 26. The microphone 27 may be connected to the sound-processing unit through an additional electrical connection (not shown) or through the electrical interface 24.

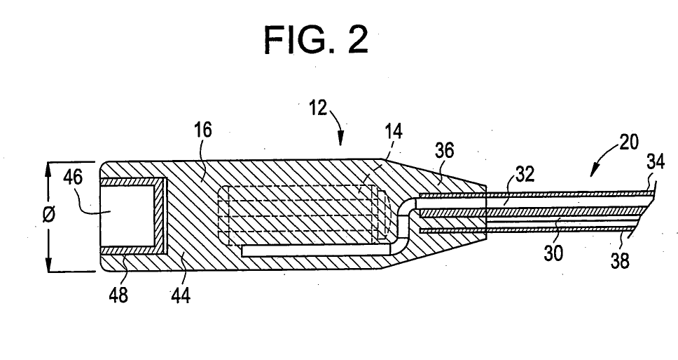

Referring now to FIG. 2, the exemplary receiver 12 and intermediate connecting portion 20 are illustrated in greater detail. The speaker 14 is illustrated as being at least partially enclosed within the casing 16. The illustrated exemplary intermediate connecting portion 20 comprises an electrical conducting component 30 and a stiffening wire 32, provided along at least a portion of the intermediate connecting portion 20. In another exemplary embodiment, the stiffening wire 32 comprises a stainless steel wire. In another exemplary embodiment, the stiffening wire 32 comprises a metal or alloy of metals having memory such that the wire may deflect and return to an original orientation. For example, the stiffening wire 32 may be a shape memory alloy.

Referring again to FIG. 2, the illustrated exemplary stiffening wire 32 is provided within or on a portion of the intermediate connecting portion 20 and extends within or on at least a portion of the receiver 12. The stiffening wire 32 in the illustrated exemplary embodiment extends through a channel 34 in the intermediate connecting portion 20, into a proximal portion 36 of the receiver 12 and alongside the speaker 14. In such embodiment, and indeed whenever the stiffening wire is used in or on any portion of the receiver 12 and the intermediate connecting portion 20, the receiver 12 may be positioned relative to the intermediate connecting portion 20 with greater stability and resiliency. Also where a stiffening wire 32 is used, the intermediate connecting portion 20 and receiver 12 may be custom manufactured or custom molded to optimize positioning of the receiver 12 within the ear canal and/or to optimize positioning of the intermediate connecting portion 20.

Referring again to FIG. 2, the illustrated electrical conducting component 30 is provided within a channel 38 within the intermediate connecting portion 20. The electrical conducting component 30 extends from the speaker 14 through the intermediate connecting component 20 to the electrical interface 24 to provide electrical connection between the sound processing unit and the speaker 14.

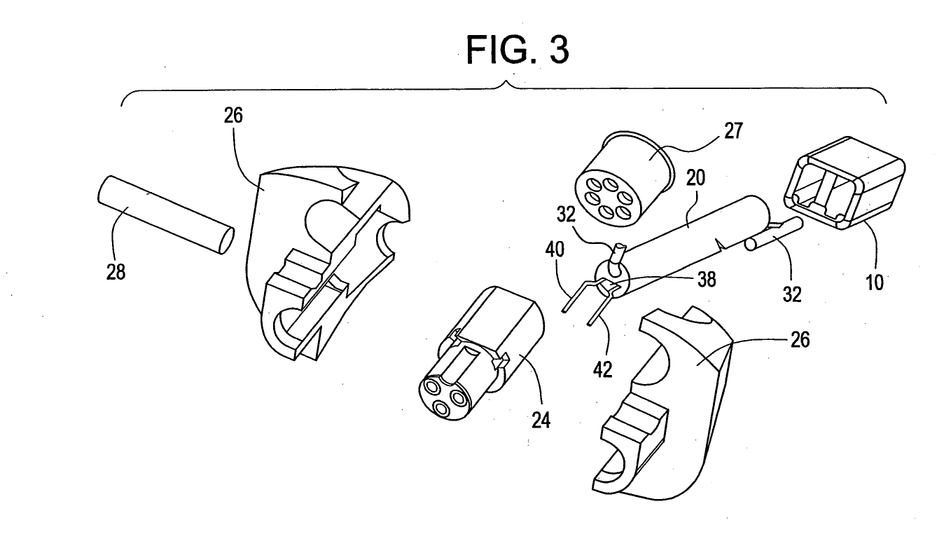

With reference to FIG. 3, in an exemplary embodiment, the electrical conducting component 30 comprises two wires 40, 42 provided within channel 38. While this embodiment illustrates both wires 40, 42 provided within the same channel 38, it is to be recognized that alternative configurations are contemplated. For example, both wires 40, 42 may share the same channel as the stiffening wire 32. Also, each wire 40, 42 may be provided within distinct channels or may be otherwise isolated from one another within the connection.

Referring again to FIG. 2, the illustrated exemplary receiver casing has first (proximal) 36 and second (distal) 44 end portions, the first end portion communicating with the intermediate connecting portion 20, the speaker 14 communicating with a port 46 provided at the second end portion 44 of the casing 16. As described by the illustrated exemplary embodiment, the casing is provided around the speaker from the intermediate connecting portion 20 to the port 46. Where non-permeable materials are used for the casing 16, the casing 16 is sealed to fluids at the first end portion 36 and along a length of the casing 16 extending from the first end portion 36 to the port 46 provided at the second end portion 44. As illustrated, the port 46 may itself be sealed to fluids by a membrane or mesh material 48. The materials used for the casing may be formed in any number of manners, including as a two shell assembly, as an overmold, or as a shrinkwrap. Any material may be used. In one exemplary embodiment, the material is a polypropylene. In another embodiment, the material is a nylon or polyethylene. The port may also be provided with a permanent or removable cerumen collection device.

Referring again to FIG. 2, the receiver has a maximum lateral dimension ø. Such dimension describes the maximum overall dimension or diameter (though it is not to be implied that the cross section of the receiver must be circular or oval) of the receiver 16. In one exemplary embodiment, the receiver has a dimension ø that is less than half the maximum lateral dimension or diameter of the user's ear canal. In another embodiment, the receiver has a dimension ø that is less than twenty percent of the maximum lateral dimension or diameter of the user's ear canal. In another embodiment, the receiver has a dimension ø that is less than ten percent of the maximum lateral dimension or diameter of the user s ear canal. In another embodiment, the receiver has a dimension ø that is less than five percent of the maximum lateral dimension or diameter of the user's ear canal.

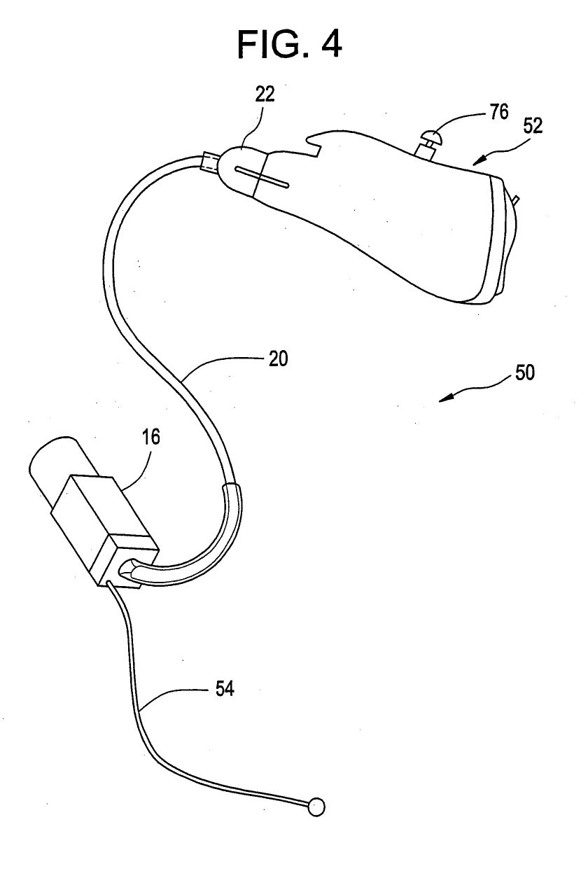

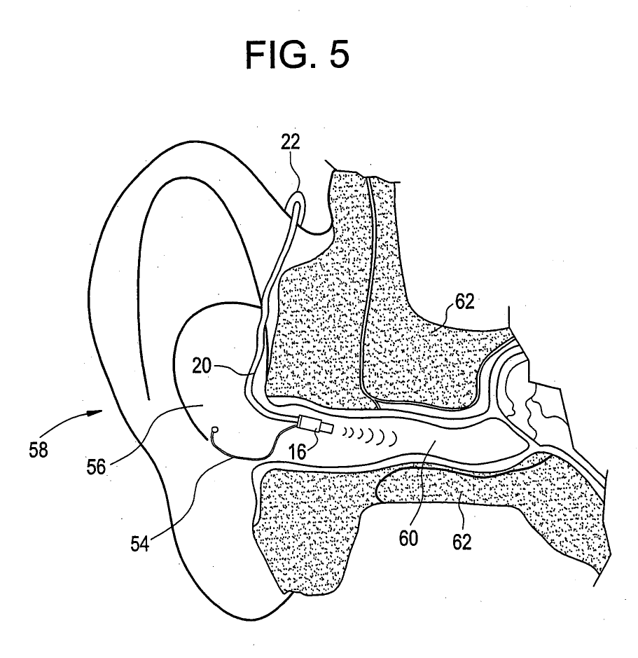

Referring now to FIG. 4, a second exemplary hearing aid system is illustrated generally at 50. The receiver 16, intermediate connecting portion 20 and sound processing unit 52 are illustrated in assembled form. Sound processing component connector 22 is illustrated as joined with the sound processing unit 52. As illustrated, an exemplary retaining wire 54 extends from the receiver 16. As illustrated by FIG. 5, the retaining wire 54 is configured to position within a portion of the concha 56 of the ear, shown generally at 58. In such embodiment, the retaining wire 54 may be configured to define an exemplary maximum insertion of the hearing aid receiver 16 into the ear canal 60. For example, the configuration of the retaining wire 54, receiver 16 and intermediate connecting portion 20 may be such that the receiver extends into the ear canal, but not into the bony regions 62 of the ear canal 60. Also, as illustrated in FIG. 5, the retaining wire 54 may be configured to cause the hearing aid receiver 16 to be suspended within a portion of the ear canal 60, such that no portion of the receiver touches the sides of the ear canal 60. While the retaining wire 54 is illustrated as extending from the receiver 16, it should be recognized that the retaining wire 54 may also or alternatively extend from the intermediate connecting portion 20.

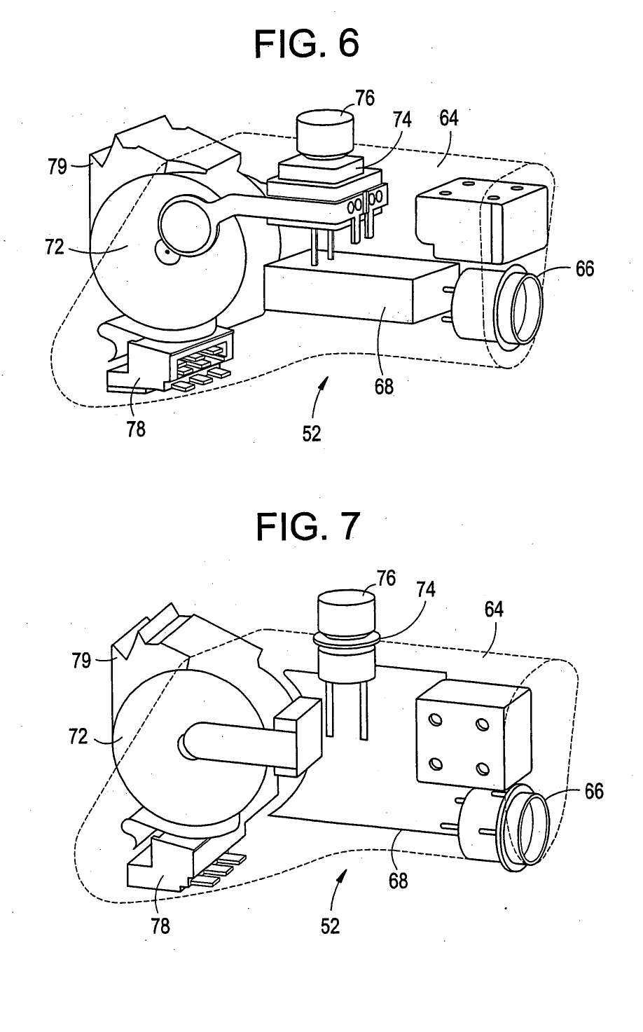

Referring now to FIG. 6, an exemplary sound processing unit (SPU) is illustrated generally at 52. The illustrated SPU 52 generally includes: a housing 64; an SPU electrical interface 66, which is illustrated as a male three-pin electrical connection, connected to an amplifier and sound processing component 68; a microphone 70 connected to the amplifier and sound processing component 68; a battery component 72 providing power to the amplifier and sound processing component 68; a switch component 74, illustrated with a push button 76 for providing a user interface with the amplifier and sound processing component 68 and/or the battery component 72; and a programming connector 78 configured to permit external programming and reprogramming of the SPU and/or to permit expansion of the hearing aid device with additional internal components. A programming correction switch 79 may be provided to permit a physician or user to control programming or reprogramming of the amplifier and sound processing component 68. Additionally, an input port (not shown) may be provided proximate thereto (or indeed, anywhere on the device) to effect programming or reprogramming of the device from an external source. Memory storage may be provided within the amplifier and sound processing component 68 and/or anywhere within the device to permit such programming and reprogramming of the SPU and/or to permit a user to select various programs via the user interface.

FIG. 7 illustrates a second exemplary SPU configuration, wherein the amplifier and sound processing component 68 is provided as a circuit board interconnecting each of the battery component 72, the switch component 74, the microphone 70 and the SPU electrical interface 66. In another exemplary embodiment, the behind the ear unit may comprise, or may additionally include, a noise generator, which may be used to generate one or more sounds. The sounds may be generated in specific frequency ranges useful to treat tinnitus. The noise generator passes such signals to the receiver for treatment.

The following table summarizes statistical analysis of data collected in the comparison of four hearing devices (G=General Hearing Instruments, O=Oticon, S=Sebotek and V=Vivatone). The tested Vivatone Device was configured in accordance with the above described embodiment(s) including the micro-receiver and the retaining wire. The Vivatone Device also was positioned within the cartilaginous region of the ear in such a manner that the receiver did not contact the walls of the ear canal.

The tested General Hearing Instruments was a canal-open-ear Auriscoe™ hearing aid. The tested Oticon Device was a low profile, Open Ear Acoustics™ configuration. The tested Sebotek Device was the PAC (Post Auricular Canal) hearing aid also described by U.S. Pat. No. 5,606,621 to Reiter, the entire contents of which are specifically incorporated herein by reference.

Thirty subjects participated in the evaluation. There were 120 runs, 4 for each participant. The data analyzed are the values of the Probe Real Ear Insertion Response Curve, which consisted of differences between the Probe Real Ear Unaided Response Curve and the Probe Real Ear Aided Response Curve and the corresponding values repeated while the subject vocalized the letter “EE”. The two differences may be called the Insertion Effect and the Occlusion Effect. Values were given at 79 frequencies (200 Hz to 8000 Hz at increments of 100 Hz).

Analysis of variance models were run for each frequency. Comparisons were adjusted for Subject variability, Order of Test, and Previous Device. The experimental error ranged over approximately 5-11 DB for the Insertion Effect and over approximately 3-8 DB for the Occlusion Effect.

Comparison results are given in the following tables. Results are given for each frequency. T-values greater than 2.444 in absolute value are included in Table 1. T-values less than 2.444 values are not to be construed as statistically insignificant simply because thay are omitted from Table 1. Negative values indicate that the Insertion Effect or Occlusion Effect was greater for the Comparison Device compared to the Vivatone Device. Positive values indicate that the Insertion Effect or Occlusion Effect was greater for the Vivatone Device compared to the Comparison Device.

The following table summarizes the comparisons at each frequency. Table values are positive or negative decibel differences. As may be seen from the tables, the Vivatone Device exhibits lower Insertion Effect across the range of frequencies as compared with the comparison devices. Indeed, it has been found that the Vivatone Device exhibits less than three decibels of insertion loss across the audible spectrum. Also, with exception of the Oticon Device in the 500 Hz to 1300 Hz range, the Vivatone device exhibits lower Occlusion Effect across the range of frequencies as compared with the comparison devices.

TABLE 1
SUMMARY OF COMPARISONS

| | Insertion Effect | | | Occlusion Effect | | |
|---|---|---|---|---|---|---|
| | G vs. V | O vs. V | S vs. V | G vs. V | O vs. V | S vs. V |
| 200 Hz | | | −28.99 | | | −8.49 |
| 300 | | | −30.56 | | | −7.92 |
| 400 | | | −31.14 | | | −7.37 |
| 500 | | | −31.32 | | +6.57 | −7.76 |
| 600 | | | −31.74 | | +9.21 | −7.89 |
| 700 | | | −32.60 | | +11.11 | −8.40 |
| 800 | | | −33.49 | | +11.64 | −8.78 |
| 900 | | | −34.11 | | +10.63 | −8.82 |
| 1000 | | | −34.83 | | +8.72 | −9.08 |
| 1100 | | | −34.78 | | +6.89 | −9.96 |
| 1200 | | | −34.56 | | +6.32 | −10.39 |
| 1300 | | −7.51 | −35.38 | | +5.32 | −11.09 |
| 1400 | | −9.01 | −36.61 | | | −13.28 |
| 1500 | | −10.52 | −37.15 | | | −14.66 |
| 1600 | | −11.47 | −37.44 | | | −15.02 |
| 1700 | | −12.37 | −37.60 | | | −15.04 |
| 1800 | | −13.49 | −37.72 | | | −16.76 |
| 1900 | | −14.87 | −38.18 | | | −18.98 |
| 2000 | | −16.20 | −38.48 | | | −20.61 |
| 2100 | | −17.24 | −38.52 | | −6.98 | −22.09 |
| 2200 | −6.88 | −18.09 | −38.29 | | −9.35 | −23.23 |
| 2300 | −7.70 | −18.77 | −38.02 | | −11.71 | −24.65 |
| 2400 | −8.49 | −19.35 | −37.57 | −6.91 | −14.08 | −26.09 |
| 2500 | −9.21 | −19.82 | −36.83 | −7.89 | −15.51 | −26.73 |
| 2600 | −9.67 | −20.14 | −35.83 | −8.04 | −15.52 | −25.94 |
| 2700 | −9.84 | −20.29 | −34.44 | −7.61 | −14.96 | −24.63 |
| 2800 | −9.86 | −20.28 | −33.03 | −7.51 | −14.66 | −23.71 |
| 2900 | −9.86 | −20.15 | −31.52 | −7.54 | −14.36 | −23.26 |
| 3000 | −9.79 | −20.02 | −30.26 | −7.48 | −14.06 | −22.09 |
| 3100 | −9.66 | −19.90 | −28.93 | −7.06 | −13.56 | −20.71 |
| 3200 | −9.51 | −19.81 | −27.73 | −7.16 | −13.49 | −19.07 |
| 3300 | −9.28 | −19.66 | −26.57 | −7.31 | −13.46 | −17.75 |
| 3400 | −9.07 | −19.56 | −25.57 | −7.23 | −13.07 | −16.73 |
| 3500 | −8.91 | −19.45 | −24.82 | −7.37 | −12.90 | −15.77 |
| 3600 | −8.69 | −19.34 | −24.16 | −6.96 | −12.01 | −14.66 |
| 3700 | −8.58 | −19.31 | −23.74 | −6.53 | −11.36 | −13.51 |
| 3800 | −8.44 | −19.34 | −23.46 | −6.28 | −10.75 | −12.41 |
| 3900 | −8.27 | −19.37 | −23.23 | −6.05 | −9.99 | −11.55 |
| 4000 | −8.09 | −19.28 | −23.03 | −5.47 | −9.21 | −10.84 |
| 4100 | −7.88 | −19.27 | −22.69 | −5.23 | −8.37 | −10.11 |
| 4200 | −7.65 | −19.21 | −22.26 | −5.11 | −7.56 | −9.52 |
| 4300 | −7.39 | −19.18 | −21.77 | −4.90 | −6.78 | −8.75 |
| 4400 | −7.15 | −19.24 | −21.18 | −4.87 | −6.07 | −8.16 |
| 4500 | −6.85 | −19.34 | −20.58 | −4.95 | −5.52 | −7.89 |
| 4600 | −6.54 | −19.37 | −19.95 | −4.58 | −4.86 | −7.36 |
| 4700 | −6.25 | −19.49 | −19.32 | −4.28 | −4.32 | −6.82 |
| 4800 | −5.95 | −19.33 | −18.65 | −3.64 | −3.69 | −6.10 |
| 4900 | −5.70 | −19.10 | −18.04 | −3.01 | −3.04 | −5.42 |
| 5000 | −5.42 | −18.71 | −17.37 | | −2.58 | −4.73 |
| 5100 | −5.13 | −18.18 | −16.68 | | | −4.30 |
| 5200 | −4.85 | −17.48 | −15.99 | | | −3.74 |
| 5300 | −4.64 | −16.81 | −15.43 | | | −3.32 |
| 5400 | | −16.01 | −14.83 | | | −3.14 |
| 5500 | | −15.18 | −14.40 | | | −3.05 |
| 5600 | | −14.42 | −14.20 | | | −2.76 |
| 5700 | | −13.57 | −14.19 | | | −2.82 |
| 5800 | | −12.90 | −14.30 | | | −3.04 |
| 5900 | | −12.24 | −14.66 | | | −3.09 |
| 6000 | | −11.64 | −15.01 | | | −2.87 |
| 6100 | | −11.03 | −15.24 | | | −2.84 |
| 6200 | | −10.50 | −15.60 | | | −2.62 |
| 6300 | | −9.93 | −15.85 | | | |
| 6400 | | −9.47 | −16.12 | | | |
| 6500 | | −9.04 | −16.43 | | | −2.53 |
| 6600 | | −8.68 | −16.76 | | | −2.75 |
| 6700 | | −8.40 | −17.02 | −2.41 | | −2.93 |
| 6800 | | −8.14 | −17.38 | −2.50 | | −3.00 |
| 6900 | | −7.86 | −17.57 | −2.94 | | −3.20 |
| 7000 | −5.37 | −7.62 | −17.64 | −3.10 | | −3.04 |
| 7100 | −5.98 | −7.41 | −17.93 | −2.93 | | −2.85 |
| 7200 | −6.54 | −7.29 | −18.20 | −2.85 | | −2.98 |
| 7300 | −6.76 | −7.08 | −18.29 | −2.83 | | −3.10 |
| 7400 | −6.83 | −6.91 | −18.37 | | | −2.88 |
| 7500 | −6.67 | −6.68 | −18.48 | | | −2.78 |
| 7600 | −6.45 | −6.52 | −18.43 | | | −2.58 |
| 7700 | −6.18 | −6.29 | −18.28 | | | |
| 7800 | −6.06 | −6.19 | −18.22 | | | |
| 7900 | −6.01 | −6.17 | −18.20 | | | |
| 8000 | −5.99 | −6.23 | −18.25 | | | |

TABLE 2
RESULTS AT 200 Hz

| | Value | Std. Error | t. value | |
|---|---|---|---|---|
| 200 Hz | | | | |
| Insertion | | | | |
| Effect | | | | |
| X1 | −3.228805324 | 2.8128462 | −1.147878383 | (General vs. |
| | | | | Vivatone) |
| X2 | −3.973763109 | 2.6132138 | −1.520642189 | (Oticon vs. |
| | | | | Vivatone) |
| X3 | −28.990360956 | 2.6890912 | −10.780728129 | (Sebotek vs. |
| | | | | Vivatone) |
| Occlusion | | | | |
| Effect | | | | |
| X1 | −1.76124202 | 2.3527289 | −0.74859539 | |
| X2 | 3.03270998 | 2.1857518 | 1.38749056 | |
| X3 | −8.48537631 | 2.2492174 | −3.77259056 | |

TABLE 3
RESULTS AT 300 Hz

| | Value | Std. Error | t. value |
|---|---|---|---|
| 300 Hz | | | |
| Insertion | | | |
| Effect | | | |
| X1 | −3.259075564 | 2.9386512 | −1.109037917 |
| X2 | −3.984400433 | 2.7300902 | −1.459439139 |
| X3 | −30.557774712 | 2.8093612 | −10.877125620 |
| Occlusion | | | |
| Effect | | | |
| X1 | −1.34258739 | 2.4706214 | −0.54342093 |
| X2 | 3.70308746 | 2.2952773 | 1.61335081 |
| X3 | −7.91842555 | 2.3619231 | −3.35253321 |

TABLE 4
RESULTS AT 400 Hz

| | Value | Std. Error | t. value |
|---|---|---|---|
| 400 Hz | | | |
| Insertion | | | |
| Effect | | | |
| X1 | −3.18071721 | 2.9913629 | −1.06330036 |
| X2 | −3.71440204 | 2.7790608 | −1.33656738 |
| X3 | −31.13784296 | 2.8597538 | −10.88829507 |
| Occlusion | | | |
| Effect | | | |
| X1 | −0.97685416 | 2.5694950 | −0.3801736 |
| X2 | 4.68242198 | 2.3871337 | 1.9615248 |
| X3 | −7.36959617 | 2.4564466 | −3.00010500 Hz |

TABLE 5
RESULTS AT 500 Hz

| | | |
|---|---|---|
| Value | Std. Error | t. value |

| | | | |
|---|---|---|---|
| 500 Hz | | | |
| Insertion | | | |
| Effect | | | |
| X1 | −3.06639030 | 3.0294176 | −1.01220456 |
| X2 | −3.35011711 | 2.8144148 | −1.19034237 |
| X3 | −31.31511356 | 2.8961342 | −10.81272859 |
| Occlusion | | | |
| Effect | | | |
| X1 | −0.42304814 | 2.5993905 | −0.16274897 |
| X2 | 6.57442272 | 2.4149074 | 2.72243260 |
| X3 | −7.76226106 | 2.4850268 | −3.12361260 |

TABLE 6
RESULTS AT 600 Hz

| | Value | Std. Error | t. value |
|---|---|---|---|
| 600 Hz | | | |
| Insertion | | | |
| Effect | | | |
| X1 | −2.8099533318 | 3.1302318 | −0.897682188 |
| X2 | −2.9480594700 | 2.9080740 | −1.013749811 |
| X3 | −31.7421838724 | 2.9925130 | −10.607200022 |
| Occlusion | | | |
| Effect | | | |
| X1 | 1.04164510 | 2.4705285 | 0.4216284 |
| X2 | 9.21450274 | 2.2951910 | 4.0146998 |
| X3 | −7.89446530 | 2.3618343 | −3.3425145 |

TABLE 7
RESULTS AT 700 Hz

| | Value | Std. Error | t. value |
|---|---|---|---|
| 700 Hz | | | |
| Insertion | | | |
| Effect | | | |
| X1 | −2.588272854 | 3.2245678 | −0.80267279 |
| X2 | −2.847366146 | 2.9957148 | −0.95047970 |
| X3 | −32.604172820 | 3.0826986 | −10.57650368 |
| Occlusion | | | |
| Effect | | | |
| X1 | 1.889389684 | 2.2700032 | 0.83232909 |
| X2 | 11.110529893 | 2.1088973 | 5.26840739 |
| X3 | −8.402816196 | 2.1701313 | −3.87203123 |

TABLE 8
RESULTS AT 800 Hz

| | Value | Std. Error | t. value |
|---|---|---|---|
| 800 Hz | | | |
| Insertion | | | |
| Effect | | | |
| X1 | −2.515782392 | 3.3207934 | −0.757584738 |
| X2 | −3.398601005 | 3.0851111 | −1.101613808 |
| X3 | −33.491112358 | 3.1746906 | −10.549409992 |
| Occlusion | | | |
| Effect | | | |
| X1 | 1.82698457 | 2.2246681 | 0.8212392 |
| X2 | 11.63631424 | 2.0667796 | 5.6301669 |
| X3 | −8.77668112 | 2.1267908 | −4.1267252 |

TABLE 9
RESULTS AT 900 Hz

| | Value | Std. Error | t. value |
|---|---|---|---|
| 900 Hz | | | |
| Insertion | | | |
| Effect | | | |
| X1 | −2.38554234 | 3.3949516 | −0.70267345 |
| X2 | −4.09229805 | 3.1540062 | −1.29749208 |
| X3 | −34.11309345 | 3.2455861 | −10.51061120 |
| Occlusion | | | |
| Effect | | | |
| X1 | 1.92054270 | 2.1612333 | 0.88863274 |
| X2 | 10.62901086 | 2.0078470 | 5.29373549 |
| X3 | −8.81972030 | 2.0661469 | −4.26868009 |

TABLE 10
RESULTS AT 1000 Hz

| | Value | Std. Error | t. value |
|---|---|---|---|
| 1000 Hz | | | |
| Insertion | | | |
| Effect | | | |
| X1 | −2.275590447 | 3.3148820 | −0.686477055 |
| X2 | −4.883197416 | 3.0796193 | −1.585649707 |
| X3 | −34.827767987 | 3.1690393 | −10.990008326 |
| Occlusion | | | |
| Effect | | | |
| X1 | 1.90850033 | 2.0273877 | 0.94135935 |
| X2 | 8.71736528 | 1.8835006 | 4.62827855 |
| X3 | −9.08163181 | 1.9381900 | −4.68562518 |

TABLE 11
RESULTS AT 1100 Hz

| | Value | Std. Error | t. value |
|---|---|---|---|
| 1100 Hz | | | |
| Insertion | | | |
| Effect | | | |
| X1 | −2.156384500 | 3.2283746 | −0.66794743 |
| X2 | −6.075641257 | 2.9992514 | −2.02571923 |
| X3 | −34.777147774 | 3.0863378 | −11.26809495 |
| Occlusion | | | |
| Effect | | | |
| X1 | 0.652209894 | 1.9516141 | 0.33418998 |
| X2 | 6.892687975 | 1.8131048 | 3.80159378 |
| X3 | −9.956084782 | 1.8657502 | −5.33623669 |

TABLE 12
RESULTS AT 1200 Hz

| | Value | Std. Error | t. value |
|---|---|---|---|
| 1200 Hz | | | |
| Insertion | | | |
| Effect | | | |
| X1 | −1.585101698 | 3.1910179 | −0.496738573 |
| X2 | −6.880732089 | 2.9645460 | −2.321006989 |
| X3 | −34.561124381 | 3.0506248 | −11.329195525 |
| Occlusion | | | |
| Effect | | | |
| X1 | 0.1712529167 | 1.9293266 | 0.088763052 |
| X2 | 6.3227648043 | 1.7923991 | 3.527543026 |
| X3 | −10.3896722765 | 1.8444433 | −5.632958487 |

TABLE 13
RESULTS AT 1300 Hz

| | Value | Std. Error | t. value |
|---|---|---|---|
| 1300 Hz | | | |
| Insertion | | | |
| Effect | | | |
| X1 | −1.1981154661 | 3.1078549 | −0.385512034 |
| X2 | −7.5105809960 | 2.8872852 | −2.601260486 |
| X3 | −35.3762012491 | 2.9711206 | −11.906686397 |
| Occlusion | | | |
| Effect | | | |
| X1 | 1.2358134856 | 1.8298857 | 0.675350090 |
| X2 | 5.3236175161 | 1.7000157 | 3.131510866 |
| X3 | −11.0905638474 | 1.7493774 | −6.339720527 |

TABLE 14
RESULTS AT 1400 Hz

| | Value | Std. Error | t. value |
|---|---|---|---|
| 1400 Hz | | | |
| Insertion | | | |
| Effect | | | |
| X1 | −1.643093468 | 3.2026055 | −0.51304897 |
| X2 | −9.006829511 | 2.9753112 | −3.02718902 |
| X3 | −36.606739445 | 3.0617025 | −11.95633446 |
| Occlusion | | | |
| Effect | | | |
| X1 | 1.218719994 | 1.7929210 | 0.67973995 |
| X2 | 3.569212245 | 1.6656744 | 2.14280315 |
| X3 | −13.277066609 | 1.7140390 | −7.74607050 |

TABLE 15
RESULTS AT 1500 Hz

| | Value | Std. Error | t. value |
|---|---|---|---|
| 1500 Hz | | | |
| Insertion | | | |
| Effect | | | |
| X1 | −2.004330563 | 3.3559284 | −0.597250692 |
| X2 | −10.520911903 | 3.1177525 | −3.374517947 |
| X3 | −37.149067713 | 3.2082798 | −11.579123521 |
| Occlusion | | | |
| Effect | | | |
| X1 | 1.565644363 | 1.9150221 | 0.81755941 |
| X2 | 3.037305910 | 1.7791098 | 1.70720543 |
| X3 | −14.661208291 | 1.8307681 | −8.00822785 |

TABLE 16
RESULTS AT 1600 Hz

| | Value | Std. Error | t. value |
|---|---|---|---|
| 1600 Hz | | | |
| Insertion | | | |
| Effect | | | |
| X1 | −1.951098286 | 3.2915707 | −0.59275600 |
| X2 | −11.474827775 | 3.0579624 | −3.75244240 |
| X3 | −37.443659502 | 3.1467536 | −11.89913947 |
| Occlusion | | | |
| Effect | | | |
| X1 | 2.19998543 | 2.0883350 | 1.05346387 |
| X2 | 2.69222085 | 1.9401223 | 1.38765520 |
| X3 | −15.01898313 | 1.9964558 | −7.52282265 |

TABLE 17
RESULTS AT 1700 Hz

| | Value | Std. Error | t. value |
|---|---|---|---|
| 1700 Hz | | | |
| Insertion | | | |
| Effect | | | |
| X1 | −2.09200068 | 3.1519854 | −0.66370887 |
| X2 | −12.37275620 | 2.9282837 | −4.22525864 |
| X3 | −37.59666754 | 3.0133095 | −12.47686870 |
| Occlusion | | | |
| Effect | | | |
| X1 | 2.296444502 | 2.1572750 | 1.06451169 |
| X2 | 2.044449766 | 2.0041696 | 1.02009817 |
| X3 | −15.035410954 | 2.0623628 | −7.29038120 |

TABLE 18
RESULTS AT 1800 Hz

| | Value | Std. Error | t. value |
|---|---|---|---|
| 1800 Hz | | | |
| Insertion | | | |
| Effect | | | |
| X1 | −2.7841781655 | 3.0546323 | −0.911460998 |
| X2 | −13.4911317442 | 2.8378399 | −4.754014423 |
| X3 | −37.7204275127 | 2.9202396 | −12.916894941 |
| Occlusion | | | |
| Effect | | | |
| X1 | 1.299973079 | 2.2825012 | 0.56953884 |
| X2 | 0.228669495 | 2.1205082 | 0.10783712 |
| X3 | −16.763530564 | 2.1820794 | −7.68236495 |

TABLE 19
RESULTS AT 1900 Hz

| | Value | Std. Error | t. value |
|---|---|---|---|
| 1900 Hz | | | |
| Insertion | | | |
| Effect | | | |
| X1 | −3.92267763 | 2.9833070 | −1.31487560 |
| X2 | −14.86697694 | 2.7715767 | −5.36408636 |
| X3 | −38.18257655 | 2.8520524 | −13.38775431 |
| Occlusion | | | |
| Effect | | | |
| X1 | −0.445001551 | 2.4921416 | −0.17856191 |
| X2 | −2.149696858 | 2.3152701 | −0.92848642 |
| X3 | −18.984168789 | 2.3824964 | −7.96818358 |

TABLE 20
RESULTS AT 2000 Hz

| | Value | Std. Error | t. value |
|---|---|---|---|
| 2000 Hz | | | |
| Insertion | | | |
| Effect | | | |
| X1 | −5.07137477 | 2.8884821 | −1.755723078 |
| X2 | −16.19593588 | 2.6834817 | −6.035418726 |
| X3 | −38.47923896 | 2.7613994 | −13.934687726 |
| Occlusion | | | |
| Effect | | | |
| X1 | −1.85628537 | 2.4314096 | −0.76346057 |
| X2 | −4.57822019 | 2.2588484 | −2.02679391 |
| X3 | −20.60848494 | 2.3244365 | −8.86601350 |

TABLE 21
RESULTS AT 2100 Hz

| | Value | Std. Error | t. value |
|---|---|---|---|
| 2100 Hz | | | |
| Insertion | | | |
| Effect | | | |
| X1 | −6.05449479 | 2.8084770 | −2.15579289 |
| X2 | −17.24123089 | 2.6091547 | −6.60797572 |
| X3 | −38.52172601 | 2.6849143 | −14.34746975 |
| Occlusion | | | |
| Effect | | | |
| X1 | −2.98680095 | 2.4258921 | −1.2312176 |
| X2 | −6.98416480 | 2.2537225 | −3.0989462 |
| X3 | −22.09045009 | 2.3191617 | −9.5251876 |

TABLE 22
RESULTS AT 2200 Hz

| | Value | Std. Error | t. value |
|---|---|---|---|
| 2200 Hz | | | |
| Insertion | | | |
| Effect | | | |
| X1 | −6.880641275 | 2.7399735 | −2.51120723 |
| X2 | −18.094100656 | 2.5455130 | −7.10823348 |
| X3 | −38.294583408 | 2.6194246 | −14.61946370 |
| Occlusion | | | |
| Effect | | | |
| X1 | −4.04732286 | 2.3505212 | −1.72188312 |
| X2 | −9.35005881 | 2.1837008 | −4.28174902 |
| X3 | −23.23487105 | 2.2471069 | −10.33990481 |

TABLE 23
RESULTS AT 2300 Hz

| | Value | Std. Error | t. value |
|---|---|---|---|
| 2300 Hz | | | |
| Insertion | | | |
| Effect | | | |
| X1 | −7.702143365 | 2.7076991 | −2.84453441 |
| X2 | −18.774332728 | 2.5155292 | −7.46337303 |
| X3 | −38.024411656 | 2.5885702 | −14.68934905 |
| Occlusion | | | |
| Effect | | | |
| X1 | −5.220130253 | 2.2482925 | −2.32181990 |
| X2 | −11.708355563 | 2.0887274 | −5.60549718 |
| X3 | −24.646487441 | 2.1493758 | −11.46681163 |

TABLE 24
RESULTS AT 2400 Hz

| | Value | Std. Error | t. value |
|---|---|---|---|
| 2400 Hz | | | |
| Insertion | | | |
| Effect | | | |
| X1 | −8.486673413 | 2.6869395 | −3.15849066 |
| X2 | −19.349755107 | 2.4962429 | −7.75155131 |
| X3 | −37.572817183 | 2.5687240 | −14.62703571 |
| Occlusion | | | |
| Effect | | | |
| X1 | −6.906049894 | 2.1583519 | −3.199686766 |
| X2 | −14.081049900 | 2.0051700 | −7.022372074 |
| X3 | −26.086046643 | 2.0633922 | −12.642311144 |

TABLE 25
RESULTS AT 2500 Hz

| | Value | Std. Error | t. value |
|---|---|---|---|
| 2500 Hz | | | |
| Insertion | | | |
| Effect | | | |
| X1 | −9.210748358 | 2.6528782 | −3.471983194 |
| X2 | −19.817120519 | 2.4645989 | −8.040708038 |
| X3 | −36.833570981 | 2.5361612 | −14.523355801 |
| Occlusion | | | |
| Effect | | | |
| X1 | −7.8887912841 | 2.1296325 | −3.704296963 |
| X2 | −15.5096824184 | 1.9784889 | −7.839155515 |
| X3 | −26.7269510910 | 2.0359364 | −13.127596011 |

TABLE 26
RESULTS AT 2600 Hz

| | Value | Std. Error | t. value |
|---|---|---|---|
| 2600 Hz | | | |
| Insertion | | | |
| Effect | | | |
| X1 | −9.66555736 | 2.6025828 | −3.71383279 |
| X2 | −20.13716999 | 2.4178731 | −8.32846424 |
| X3 | −35.82550481 | 2.4880786 | −14.39886359 |
| Occlusion | | | |
| Effect | | | |
| X1 | −8.039373e+000 | 2.0445271 | −3.9321428795 |
| X2 | −1.552271e+001 | 1.8994236 | −8.1723244632 |
| X3 | −2.594425e+001 | 1.9545753 | −13.2736008791 |

TABLE 27
RESULTS AT 2700 Hz

| | Value | Std. Error | t. value |
|---|---|---|---|
| 2700 Hz | | | |
| Insertion | | | |
| Effect | | | |
| X1 | −9.8422402627 | 2.4996242 | −3.937488045 |
| X2 | −20.2943035971 | 2.3222216 | −8.739175965 |
| X3 | −34.4411171164 | 2.3896498 | −14.412621118 |
| Occlusion | | | |
| Effect | | | |
| X1 | −7.613859887 | 1.9209320 | −3.963627961 |
| X2 | −14.957610998 | 1.7846003 | −8.381490995 |
| X3 | −24.625003741 | 1.8364180 | −13.409258493 |

TABLE 28
RESULTS AT 2800 Hz

| | Value | Std. Error | t. value |
|---|---|---|---|
| 2800 Hz | | | |
| Insertion | | | |
| Effect | | | |
| X1 | −9.86365196 | 2.3996114 | −4.1105206 |
| X2 | −20.27641387 | 2.2293069 | −9.0953891 |
| X3 | −33.03347336 | 2.2940372 | −14.3997113 |
| Occlusion | | | |
| Effect | | | |
| X1 | −7.50588772 | 1.8590431 | −4.0375006 |
| X2 | −14.65670749 | 1.7271037 | −8.4862926 |
| X3 | −23.70698104 | 1.7772520 | −13.3391220 |

TABLE 29
RESULTS AT 2900 Hz

| | Value | Std. Error | t. value |
|---|---|---|---|
| 2900 Hz | | | |
| Insertion | | | |
| Effect | | | |
| X1 | −9.86079168 | 2.2699771 | −4.34400497 |
| X2 | −20.15133560 | 2.1088730 | −9.55549987 |
| X3 | −31.52307174 | 2.1701063 | −14.52604933 |
| Occlusion | | | |
| Effect | | | |
| X1 | −7.543366871 | 1.8062716 | −4.17620855 |
| X2 | −14.359771755 | 1.6780775 | −8.55727583 |
| X3 | −23.256473650 | 1.7268022 | −13.46794292 |

TABLE 30
RESULTS AT 3000 Hz

| | Value | Std. Error | t. value |
|---|---|---|---|
| 3000 Hz | | | |
| Insertion | | | |
| Effect | | | |
| X1 | −9.7856477447 | 2.1508276 | −4.549712685 |
| X2 | −20.0236465366 | 1.9981798 | −10.020943400 |
| X3 | −30.2576796218 | 2.0561990 | −14.715345668 |
| Occlusion | | | |
| Effect | | | |
| X1 | −7.47719814 | 1.74153648 | −4.29344904 |
| X2 | −14.06177565 | 1.61793672 | −8.69117777 |
| X3 | −22.09160667 | 1.66491522 | −13.26890791 |

TABLE 31
RESULTS AT 3100 Hz

| | Value | Std. Error | t. value |
|---|---|---|---|
| 3100 Hz | | | |
| Insertion | | | |
| Effect | | | |
| X1 | −9.664299909 | 2.0441730 | −4.727730813 |
| X2 | −19.902779737 | 1.8990947 | −10.480140962 |
| X3 | −28.927085690 | 1.9542369 | −14.802241273 |
| Occlusion | | | |
| Effect | | | |
| X1 | −7.058142664 | 1.68138544 | −4.197813587 |
| X2 | −13.560497213 | 1.56205470 | −8.681192285 |
| X3 | −20.712909615 | 1.60741060 | −12.885885895 |

TABLE 32
RESULTS AT 3200 Hz

| | Value | Std. Error | t. value |
|---|---|---|---|
| 3200 Hz | | | |
| Insertion | | | |
| Effect | | | |
| X1 | −9.510894160 | 1.9521516 | −4.87200583 |
| X2 | −19.806347612 | 1.8136042 | −10.92098708 |
| X3 | −27.726410309 | 1.8662641 | −14.85663835 |
| Occlusion | | | |
| Effect | | | |
| X1 | −7.163145949 | 1.64523049 | −4.353885967 |
| X2 | −13.488540806 | 1.52846573 | −8.824889289 |
| X3 | −19.070659369 | 1.57284634 | −12.124934858 |

TABLE 33
RESULTS AT 3300 Hz

| | Value | Std. Error | t. value |
|---|---|---|---|
| 3300 Hz | | | |
| Insertion | | | |
| Effect | | | |
| X1 | −9.2786068378 | 1.8838049 | −4.925460512 |
| X2 | −19.6593344393 | 1.7501081 | −11.233211221 |
| X3 | −26.5719530600 | 1.8009244 | −14.754619026 |
| Occlusion | | | |
| Effect | | | |
| X1 | −7.31237040 | 1.66005982 | −4.40488366 |
| X2 | −13.45522787 | 1.54224259 | −8.72445614 |
| X3 | −17.74897246 | 1.58702323 | −11.18381389 |

TABLE 34
RESULTS AT 3400 Hz

| | Value | Std. Error | t. value |
|---|---|---|---|
| 3400 Hz | | | |
| Insertion | | | |
| Effect | | | |
| X1 | −9.066209111 | 1.8323300 | −4.94791271 |
| X2 | −19.556815995 | 1.7022865 | −11.48855723 |
| X3 | −25.574072634 | 1.7517142 | −14.59945508 |
| Occlusion | | | |
| Effect | | | |
| X1 | −7.23388315 | 1.70948608 | −4.2316128 |
| X2 | −13.07226920 | 1.58816098 | −8.2310731 |
| X3 | −16.72753874 | 1.63427491 | −10.2354498 |

TABLE 35
RESULTS AT 3500 Hz

| | Value | Std. Error | t. value |
|---|---|---|---|
| 3500 Hz | | | |
| Insertion | | | |
| Effect | | | |
| X1 | −8.91013789 | 1.7886133 | −4.98158981 |
| X2 | −19.45460034 | 1.6616724 | −11.70784323 |
| X3 | −24.81692370 | 1.7099208 | −14.51349273 |
| Occlusion | | | |
| Effect | | | |
| X1 | −7.3687376481 | 1.76527541 | −4.174270831 |
| X2 | −12.8957066864 | 1.63999085 | −7.863279640 |
| X3 | −15.7692838620 | 1.68760971 | −9.344153291 |

TABLE 36
RESULTS AT 3600 Hz

| | Value | Std. Error | t. value |
|---|---|---|---|
| 3600 Hz | | | |
| Insertion | | | |
| Effect | | | |
| X1 | −8.691367288 | 1.7763295 | −4.89288013 |
| X2 | −19.342423503 | 1.6502604 | −11.72083106 |
| X3 | −24.157524195 | 1.6981775 | −14.22555931 |
| Occlusion | | | |
| Effect | | | |
| X1 | −6.962227987 | 1.76558948 | −3.94328809 |
| X2 | −12.008873432 | 1.64028264 | −7.32122206 |
| X3 | −14.662004950 | 1.68790997 | −8.68648519 |

TABLE 37
RESULTS AT 3700 Hz

| | Value | Std. Error | t. value |
|---|---|---|---|
| 3700 Hz | | | |
| Insertion | | | |
| Effect | | | |
| X1 | −8.583079332 | 1.76270385 | −4.86926908 |
| X2 | −19.313847560 | 1.63760180 | −11.79398287 |
| X3 | −23.737175524 | 1.68515129 | −14.08607978 |
| Occlusion | | | |
| Effect | | | |
| X1 | −6.5337475500 | 1.74265157 | −3.749313783 |
| X2 | −11.3626632173 | 1.61897267 | −7.018440431 |
| X3 | −13.5120469265 | 1.66598124 | −8.110563666 |

TABLE 38
RESULTS AT 3800 Hz

| | Value | Std. Error | t. value |
|---|---|---|---|
| 3800 Hz | | | |
| Insertion | | | |
| Effect | | | |
| X1 | −8.441467426 | 1.75635543 | −4.80624097 |
| X2 | −19.336107428 | 1.63170394 | −11.85025478 |
| X3 | −23.463879959 | 1.67908218 | −13.97422961 |
| Occlusion | | | |
| Effect | | | |
| X1 | −6.278133968 | 1.68496687 | −3.72596880 |
| X2 | −10.754862789 | 1.56538194 | −6.87044005 |
| X3 | −12.412324737 | 1.61083445 | −7.70552474 |

TABLE 39
RESULTS AT 3900 Hz

| | Value | Std. Error | t. value |
|---|---|---|---|
| 3900 Hz | | | |
| Insertion | | | |
| Effect | | | |
| X1 | −8.270799727 | 1.76899901 | −4.67541231 |
| X2 | −19.372231987 | 1.64345018 | −11.78753833 |
| X3 | −23.226956475 | 1.69116949 | −13.73425708 |
| Occlusion | | | |
| Effect | | | |
| X1 | −6.04925683 | 1.66204356 | −3.6396500 |
| X2 | −9.99092084 | 1.54408554 | −6.4704452 |
| X3 | −11.55100361 | 1.58891969 | −7.2697215 |

TABLE 40
RESULTS AT 4000 Hz

| | Value | Std. Error | t. value |
|---|---|---|---|
| 4000 Hz | | | |
| Insertion | | | |
| Effect | | | |
| X1 | −8.086843450 | 1.72954953 | −4.67569348 |
| X2 | −19.275861570 | 1.60680050 | −11.99642501 |
| X3 | −23.027648032 | 1.65345564 | −13.92698265 |
| Occlusion | | | |
| Effect | | | |
| X1 | −5.468606286 | 1.53347467 | −3.56615364 |
| X2 | −9.213260489 | 1.42464140 | −6.46707337 |
| X3 | −10.842963904 | 1.46600737 | −7.39625472 |

TABLE 41
RESULTS AT 4100 Hz

| | Value | Std. Error | t. value |
|---|---|---|---|
| 4100 Hz | | | |
| Insertion | | | |
| Effect | | | |
| X1 | −7.881860321 | 1.70361988 | −4.62653695 |
| X2 | −19.265070702 | 1.58271112 | −12.17219647 |
| X3 | −22.687028158 | 1.62866680 | −13.92981556 |
| Occlusion | | | |
| Effect | | | |
| X1 | −5.234017037 | 1.44847923 | −3.613456733 |
| X2 | −8.367227067 | 1.34567823 | −6.217851237 |
| X3 | −10.113523797 | 1.38475142 | −7.303494094 |

TABLE 42
RESULTS AT 4200 Hz
4200 Hz

| | | |
|---|---|---|
| Value | Std.Error | t.value |

Insertion Effect

| | | | |
|---|---|---|---|
| X1 | −7.650776971 | 1.67932983 | −4.55585129 |
| X2 | −19.207194367 | 1.56014498 | −12.31115996 |
| X3 | −22.260182017 | 1.60544543 | −13.86542428 |

Occlusion Effect

| | | | |
|---|---|---|---|
| X1 | −5.1074935588 | 1.37868912 | −3.704601341 |
| X2 | −7.5586894898 | 1.28084124 | −5.901347685 |
| X3 | −9.5194610061 | 1.31803181 | −7.222481964 |

TABLE 43
RESULTS AT 4300 Hz
4300 Hz

| | | |
|---|---|---|
| Value | Std.Error | t.value |

Insertion Effect

| | | | |
|---|---|---|---|
| X1 | −7.390373789 | 1.65707945 | −4.45987897 |
| X2 | −19.182103586 | 1.53947374 | −12.46016937 |
| X3 | −21.767082631 | 1.58417398 | −13.74033587 |

Occlusion Effect

| | | | |
|---|---|---|---|
| X1 | −4.8960648158 | 1.30757620 | −3.744382017 |
| X2 | −6.7790754700 | 1.21477533 | −5.580517913 |
| X3 | −8.7460200811 | 1.25004761 | −6.996549598 |

TABLE 44
RESULTS AT 4400 Hz
4400 Hz

| | | |
|---|---|---|
| Value | Std.Error | t.value |

Insertion Effect

| | | | |
|---|---|---|---|
| X1 | −7.146230694 | 1.63780680 | −4.36329284 |
| X2 | −19.243600045 | 1.52156891 | −12.64720903 |
| X3 | −21.178776976 | 1.56574926 | −13.52628895 |

Occlusion Effect

| | | | |
|---|---|---|---|
| X1 | −4.87065603 | 1.25303258 | −3.88709449 |
| X2 | −6.06657954 | 1.16410275 | −5.21137805 |
| X3 | −8.16174608 | 1.19790370 | −6.81335742 |

TABLE 45
RESULTS AT 4500 Hz
4500 Hz

| | | |
|---|---|---|
| Value | Std.Error | t.value |

Insertion Effect

| | | | |
|---|---|---|---|
| X1 | −6.847453349 | 1.63031020 | −4.20009231 |
| X2 | −19.340813305 | 1.51460436 | −12.76954819 |
| X3 | −20.581624580 | 1.55858249 | −13.20534829 |

Occlusion Effect

| | | | |
|---|---|---|---|
| X1 | −4.952060307 | 1.20193410 | −4.12007640 |
| X2 | −5.516111259 | 1.11663082 | −4.93995971 |
| X3 | −7.888428986 | 1.14905337 | −6.86515456 |

TABLE 46
RESULTS AT 4600 Hz
4600 Hz

| | | |
|---|---|---|
| Value | Std.Error | t.value |

Insertion Effect

| | | | |
|---|---|---|---|
| X1 | −6.536781665 | 1.63166742 | −4.00619732 |
| X2 | −19.370563786 | 1.51586525 | −12.77855257 |
| X3 | −19.946411210 | 1.55987999 | −12.78714471 |

Occlusion Effect

| | | | |
|---|---|---|---|
| X1 | −4.583931130 | 1.20319291 | −3.80980565 |
| X2 | −4.866591929 | 1.11780029 | −4.35372220 |
| X3 | −7.363325177 | 1.15025680 | −6.40146201 |

TABLE 47
RESULTS AT 4700 Hz
4700 Hz

| | | |
|---|---|---|
| Value | Std.Error | t.value |

Insertion Effect

| | | | |
|---|---|---|---|
| X1 | −6.247439739 | 1.64057349 | −3.80808282 |
| X2 | −19.485709545 | 1.52413924 | −12.78473056 |
| X3 | −19.320813101 | 1.56839423 | −12.31884990 |

Occlusion Effect

| | | | |
|---|---|---|---|
| X1 | −4.277111412 | 1.20635740 | −3.54547616 |
| X2 | −4.319781388 | 1.12074019 | −3.85440034 |
| X3 | −6.818258071 | 1.15328207 | −5.91204726 |

TABLE 48
RESULTS AT 4800 Hz
4800 Hz

| | | |
|---|---|---|
| Value | Std.Error | t.value |

Insertion Effect

| | | | |
|---|---|---|---|
| X1 | −5.9496237669 | 1.65009622 | −3.605622326 |
| X2 | −19.3341460166 | 1.53298612 | −12.612081555 |
| X3 | −18.6504311493 | 1.57749799 | −11.822792342 |

Occlusion Effect

| | | | |
|---|---|---|---|
| X1 | −3.63533451 | 1.19702245 | −3.03698108 |
| X2 | −3.68529686 | 1.11206776 | −3.31391396 |
| X3 | −6.10429061 | 1.14435781 | −5.33424995 |

TABLE 49
RESULTS AT 4900 Hz
4900 Hz

| | | |
|---|---|---|
| Value | Std.Error | t.value |

Insertion Effect

| | | | |
|---|---|---|---|
| X1 | −5.69900795 | 1.67201132 | −3.40847449 |
| X2 | −19.09922740 | 1.55334588 | −12.29554066 |
| X3 | −18.04055946 | 1.59844891 | −11.28629094 |

Occlusion Effect

| | | | |
|---|---|---|---|
| X1 | −3.007209843 | 1.15216066 | −2.61006121 |
| X2 | −3.037454396 | 1.07038989 | −2.83770842 |
| X3 | −5.416608544 | 1.10146978 | −4.91761883 |

TABLE 50
RESULTS AT 5000 Hz
5000 Hz

| | | |
|---|---|---|
| Value | Std.Error | t.value |

Insertion Effect

| | | | |
|---|---|---|---|
| X1 | −5.42096921 | 1.69550964 | −3.19725060 |
| X2 | −18.70751384 | 1.57517648 | −11.87645583 |
| X3 | −17.36767314 | 1.62091338 | −10.71474474 |

Occlusion Effect

| | | | |
|---|---|---|---|
| X1 | −2.649642968 | 1.11875070 | −2.36839447 |
| X2 | −2.583699149 | 1.03935109 | −2.48587718 |
| X3 | −4.726811994 | 1.06952974 | −4.41952366 |

TABLE 51
RESULTS AT 5100 Hz
5100 Hz

| | | |
|---|---|---|
| Value | Std.Error | t.value |

Insertion Effect

| | | | |
|---|---|---|---|
| X1 | −5.12838471 | 1.72005712 | −2.98152000 |
| X2 | −18.18322864 | 1.59798178 | −11.37887104 |
| X3 | −16.68033428 | 1.64438087 | −10.14383871 |

Occlusion Effect

| | | | |
|---|---|---|---|
| X1 | −2.350640296 | 1.06203444 | −2.21333717 |
| X2 | −2.222199512 | 0.98666007 | −2.25224428 |
| X3 | −4.297318170 | 1.01530879 | −4.23252337 |

TABLE 52
RESULTS AT 5200 Hz

| | Value | Std. Error | t. value |
|---|---|---|---|
| 5200 Hz | | | |
| Insertion | | | |
| Effect | | | |
| X1 | −4.846893396 | 1.73104035 | −2.79998868 |
| X2 | −17.483734536 | 1.60818552 | −10.87171496 |
| X3 | −15.991399029 | 1.65488088 | −9.66317230 |
| Occlusion | | | |
| Effect | | | |
| X1 | −1.863905114 | 1.02038103 | −1.82667559 |
| X2 | −1.588450835 | 0.94796287 | −1.67564667 |
| X3 | −3.737920520 | 0.97548797 | −3.83184685 |

TABLE 53
RESULTS AT 5300 Hz

| | Value | Std. Error | t. value |
|---|---|---|---|
| 5300 Hz | | | |
| Insertion | | | |
| Effect | | | |
| X1 | −4.635811384 | 1.74762530 | −2.65263463 |
| X2 | −16.806580187 | 1.62359340 | −10.35147110 |
| X3 | −15.434734844 | 1.67073615 | −9.23828390 |
| Occlusion | | | |
| Effect | | | |
| X1 | −1.55178690 | 0.94658159 | −1.6393588 |
| X2 | −1.11156094 | 0.87940111 | −1.2639977 |
| X3 | −3.32312975 | 0.90493544 | −3.6722285 |

TABLE 54
RESULTS AT 5400 Hz

| | Value | Std. Error | t. value |
|---|---|---|---|
| 5400 Hz | | | |
| Insertion | | | |
| Effect | | | |
| X1 | −4.296048437 | 1.76786473 | −2.430077577 |
| X2 | −16.007405575 | 1.64239640 | −9.746371538 |
| X3 | −14.827069029 | 1.69008511 | −8.772971794 |
| Occlusion | | | |
| Effect | | | |
| X1 | −1.357632686 | 0.92688227 | −1.46473044 |
| X2 | −1.085022430 | 0.86109989 | −1.26004247 |
| X3 | −3.141020167 | 0.88610283 | −3.54475809 |

TABLE 55
RESULTS AT 5500 Hz

| | Value | Std. Error | t. value |
|---|---|---|---|
| 5500 Hz | | | |
| Insertion | | | |
| Effect | | | |
| X1 | −4.040537444 | 1.7891974 | −2.258296111 |
| X2 | −15.177478550 | 1.6622150 | −9.130875559 |
| X3 | −14.401720605 | 1.7104792 | −8.419699405 |
| Occlusion | | | |
| Effect | | | |
| X1 | −1.172678260 | 0.90954444 | −1.28930287 |
| X2 | −1.124977061 | 0.84499255 | −1.33134554 |
| X3 | −3.053792404 | 0.86952779 | −3.51201241 |

TABLE 56
RESULTS AT 5600 Hz

| | Value | Std. Error | t. value |
|---|---|---|---|
| 5600 Hz | | | |
| Insertion | | | |
| Effect | | | |
| X1 | −3.842925160 | 1.8254446 | −2.10519960 |
| X2 | −14.418027712 | 1.6958897 | −8.50174849 |
| X3 | −14.202779253 | 1.7451316 | −8.13851454 |
| Occlusion | | | |
| Effect | | | |
| X1 | −0.949080983 | 0.92183414 | −1.02955721 |
| X2 | −0.951847054 | 0.85641002 | −1.11143848 |
| X3 | −2.755459070 | 0.88127679 | −3.12666701 |

TABLE 57
RESULTS AT 5700 Hz

| | Value | Std. Error | t. value |
|---|---|---|---|
| 5700 Hz | | | |
| Insertion | | | |
| Effect | | | |
| X1 | −3.696893582 | 1.8553649 | −1.99254262 |
| X2 | −13.570943809 | 1.7236865 | −7.87320879 |
| X3 | −14.186977436 | 1.7737356 | −7.99836104 |
| Occlusion | | | |
| Effect | | | |
| X1 | −0.981408120 | 0.94246447 | −1.04132108 |
| X2 | −1.137744866 | 0.87557619 | −1.29942417 |
| X3 | −2.818453141 | 0.90099947 | −3.12814075 |

TABLE 58
RESULTS AT 5800 Hz

| | Value | Std. Error | t. value |
|---|---|---|---|
| 5800 Hz | | | |
| Insertion | | | |
| Effect | | | |
| X1 | −3.485335327 | 1.9118784 | −1.82299003 |
| X2 | −12.900093591 | 1.7761892 | −7.26279241 |
| X3 | −14.302358724 | 1.8277627 | −7.82506305 |
| Occlusion | | | |
| Effect | | | |
| X1 | −1.43215721 | 0.99833534 | −1.4345452 |
| X2 | −1.30174219 | 0.92748180 | −1.4035232 |
| X3 | −3.03832890 | 0.95441221 | −3.1834556 |

TABLE 59
RESULTS AT 5900 Hz

| | Value | Std. Error | t. value |
|---|---|---|---|
| 5900 Hz | | | |
| Insertion | | | |
| Effect | | | |
| X1 | −3.470882999 | 1.9551480 | −1.77525331 |
| X2 | −12.237829059 | 1.8163879 | −6.73745358 |
| X3 | −14.656469432 | 1.8691286 | −7.84133809 |
| Occlusion | | | |
| Effect | | | |
| X1 | −1.570601603 | 1.01546928 | −1.54667564 |
| X2 | −1.143278073 | 0.94339973 | −1.21187026 |
| X3 | −3.089089793 | 0.97079233 | −3.18202946 |

TABLE 60
RESULTS AT 6000 Hz

| | Value | Std. Error | t. value |
|---|---|---|---|
| 6000 Hz | | | |
| Insertion | | | |
| Effect | | | |
| X1 | −3.505504506 | 1.9935030 | −1.75846459 |
| X2 | −11.643669192 | 1.8520208 | −6.28700782 |
| X3 | −15.008307749 | 1.9057962 | −7.87508551 |
| Occlusion | | | |
| Effect | | | |
| X1 | −1.4782767934 | 1.03060693 | −1.43437498 |
| X2 | −0.9518932129 | 0.95746303 | −0.99418273 |
| X3 | −2.8687898427 | 0.98526398 | −2.91169667 |

TABLE 61
RESULTS AT 6100 Hz

| | Value | Std. Error | t. value |
|---|---|---|---|
| 6100 Hz | | | |
| Insertion | | | |
| Effect | | | |
| X1 | −3.527926580 | 2.0085812 | −1.75642715 |
| X2 | −11.026150510 | 1.8660288 | −5.90888537 |
| X3 | −15.238089915 | 1.9202110 | −7.93563327 |
| Occlusion | | | |
| Effect | | | |
| X1 | −1.581128817 | 1.06615246 | −1.48302319 |
| X2 | −0.690258914 | 0.99048583 | −0.69688924 |
| X3 | −2.842076531 | 1.01924563 | −2.78841179 |

TABLE 62
RESULTS AT 6200 Hz

| | Value | Std. Error | t. value |
|---|---|---|---|
| 6200 Hz | | | |
| Insertion | | | |
| Effect | | | |
| X1 | −3.541042894 | 2.0249469 | −1.748709011 |
| X2 | −10.499983894 | 1.8812330 | −5.581437152 |
| X3 | −15.602866439 | 1.9358566 | −8.059928816 |
| Occlusion | | | |
| Effect | | | |
| X1 | −1.560048975 | 1.10174868 | −1.41597535 |
| X2 | −0.553851718 | 1.02355573 | −0.54110558 |
| X3 | −2.615469069 | 1.05327575 | −2.48317600 |

TABLE 63
RESULTS AT 6300 Hz

| | Value | Std. Error | t. value |
|---|---|---|---|
| 6300 Hz | | | |
| Insertion | | | |
| Effect | | | |
| X1 | −3.64729645 | 2.0274164 | −1.79898731 |
| X2 | −9.92894474 | 1.8835273 | −5.27146316 |
| X3 | −15.85389666 | 1.9382175 | −8.17962727 |
| Occlusion | | | |
| Effect | | | |
| X1 | −1.38042349 | 1.09173705 | −1.26442854 |
| X2 | −0.37261352 | 1.01425464 | −0.36737669 |
| X3 | −2.33816761 | 1.04370459 | −2.24025804 |

TABLE 64
RESULTS AT 6400 Hz

| | Value | Std. Error | t. value |
|---|---|---|---|
| 6400 Hz | | | |
| Insertion | | | |
| Effect | | | |
| X1 | −3.72431243 | 2.0226028 | −1.84134638 |
| X2 | −9.47118863 | 1.8790553 | −5.04039902 |
| X3 | −16.11724147 | 1.9336157 | −8.33528692 |
| Occlusion | | | |
| Effect | | | |
| X1 | −1.391813985 | 1.05689378 | −1.31689107 |
| X2 | −0.267321456 | 0.98188426 | −0.27225353 |
| X3 | −2.187831043 | 1.01039430 | −2.16532401 |

TABLE 65
RESULTS AT 6500 Hz

| | Value | Std. Error | t. value |
|---|---|---|---|
| 6500 Hz | | | |
| Insertion | | | |
| Effect | | | |
| X1 | −3.713274489 | 2.0281956 | −1.83082665 |
| X2 | −9.044965698 | 1.8842511 | −4.80029737 |
| X3 | −16.426047721 | 1.9389623 | −8.47156616 |
| Occlusion | | | |
| Effect | | | |
| X1 | −1.731417523 | 1.01416531 | −1.707234029 |
| X2 | −0.548784418 | 0.94218829 | −0.582457266 |
| X3 | −2.528227998 | 0.96954572 | −2.607641843 |

TABLE 66
RESULTS AT 6600 Hz

| | Value | Std. Error | t. value |
|---|---|---|---|
| 6600 Hz | | | |
| Insertion | | | |
| Effect | | | |
| X1 | −3.766690641 | 2.0267967 | −1.85844519 |
| X2 | −8.678056381 | 1.8829516 | −4.60875176 |
| X3 | −16.764044366 | 1.9376251 | −8.65185156 |
| Occlusion | | | |
| Effect | | | |
| X1 | −1.98956391 | 0.95040501 | −2.09338533 |
| X2 | −1.10722139 | 0.88295317 | −1.25399786 |
| X3 | −2.75192688 | 0.90859065 | −3.02878627 |

TABLE 67
RESULTS AT 6700 Hz

| | Value | Std. Error | t. value |
|---|---|---|---|
| 6700 Hz | | | |
| Insertion | | | |
| Effect | | | |
| X1 | −4.014308937 | 2.0434736 | −1.96445358 |
| X2 | −8.397504120 | 1.8984448 | −4.42335962 |
| X3 | −17.021841498 | 1.9535682 | −8.71320587 |
| Occlusion | | | |
| Effect | | | |
| X1 | −2.407488315 | 0.94010973 | −2.5608588 |
| X2 | −1.341366154 | 0.87338857 | −1.5358183 |
| X3 | −2.928638691 | 0.89874832 | −3.2585749 |

TABLE 68
RESULTS AT 6800 Hz

| | Value | Std. Error | t. value |
|---|---|---|---|
| 6800 Hz | | | |
| Insertion | | | |
| Effect | | | |
| X1 | −4.354917941 | 2.0694860 | −2.10434760 |
| X2 | −8.141998692 | 1.9226111 | −4.23486507 |
| X3 | −17.378004698 | 1.9784362 | −8.78370757 |
| Occlusion | | | |
| Effect | | | |
| X1 | −2.500115515 | 0.98440958 | −2.5397107 |
| X2 | −1.447595547 | 0.91454438 | −1.5828598 |
| X3 | −2.996861320 | 0.94109914 | −3.1844268 |

TABLE 69
RESULTS AT 6900 Hz

| | Value | Std. Error | t. value |
|---|---|---|---|
| 6900 Hz | | | |
| Insertion | | | |
| Effect | | | |
| X1 | −4.748185680 | 2.1060634 | −2.25453122 |
| X2 | −7.861928357 | 1.9565925 | −4.01817352 |
| X3 | −17.572263041 | 2.0134043 | −8.72763772 |
| Occlusion | | | |
| Effect | | | |
| X1 | −2.943078973 | 1.02579595 | −2.8690686 |
| X2 | −1.751442140 | 0.95299349 | −1.8378322 |
| X3 | −3.203777402 | 0.98066466 | −3.2669449 |

TABLE 70
RESULTS AT 7000 Hz

| | Value | Std. Error | t. value |
|---|---|---|---|
| 7000 Hz | | | |
| Insertion | | | |
| Effect | | | |
| X1 | −5.36964885 | 2.1060878 | −2.54958453 |
| X2 | −7.62145160 | 1.9566152 | −3.89522250 |
| X3 | −17.63774396 | 2.0134276 | −8.76005873 |
| Occlusion | | | |
| Effect | | | |
| X1 | −3.0958671835 | 1.09618801 | −2.824211866 |
| X2 | −1.6347488389 | 1.01838971 | −1.605229143 |
| X3 | −3.0436625264 | 1.04795973 | −2.904369750 |

TABLE 71
RESULTS AT 7100 Hz

| | Value | Std. Error | t. value |
|---|---|---|---|
| 7100 Hz | | | |
| Insertion | | | |
| Effect | | | |
| X1 | −5.979052985 | 2.1484033 | −2.78302176 |
| X2 | −7.409193538 | 1.9959275 | −3.71215570 |
| X3 | −17.930145965 | 2.0538813 | −8.72988412 |
| Occlusion | | | |
| Effect | | | |
| X1 | −2.93400085 | 1.12940070 | −2.59783871 |
| X2 | −1.35279652 | 1.04924523 | −1.28930442 |
| X3 | −2.84600351 | 1.07971117 | −2.63589335 |

TABLE 72
RESULTS AT 7200 Hz

| | Value | Std. Error | t. value |
|---|---|---|---|
| 7200 Hz | | | |
| Insertion | | | |
| Effect | | | |
| X1 | −6.53523989 | 2.1790642 | −2.9991039 |
| X2 | −7.29180932 | 2.0244124 | −3.6019388 |
| X3 | −18.20102578 | 2.0831933 | −8.7370797 |
| Occlusion | | | |
| Effect | | | |
| X1 | −2.854334671 | 1.13785077 | −2.50853165 |
| X2 | −1.261150721 | 1.05709559 | −1.19303375 |
| X3 | −2.983604193 | 1.08778948 | −2.74281399 |

TABLE 73
RESULTS AT 7300 Hz

| | Value | Std. Error | t. value |
|---|---|---|---|
| 7300 Hz | | | |
| Insertion | | | |
| Effect | | | |
| X1 | −6.75636148 | 2.2050562 | −3.06403143 |
| X2 | −7.08463282 | 2.0485597 | −3.45834830 |
| X3 | −18.28648048 | 2.1080417 | −8.67462921 |
| Occlusion | | | |
| Effect | | | |
| X1 | −2.82929369 | 1.10910247 | −2.55097593 |
| X2 | −1.27314769 | 1.03038760 | −1.23560075 |
| X3 | −3.10192981 | 1.06030599 | −2.92550437 |

TABLE 74
RESULTS AT 7400 Hz

| | Value | Std. Error | t. value |
|---|---|---|---|
| 7400 Hz | | | |
| Insertion | | | |
| Effect | | | |
| X1 | −6.83076637 | 2.2407210 | −3.04846800 |
| X2 | −6.91081533 | 2.0816933 | −3.31980476 |
| X3 | −18.37488422 | 2.1421375 | −8.57782685 |
| Occlusion | | | |
| Effect | | | |
| X1 | −2.49001160 | 1.07112286 | −2.3246741 |
| X2 | −1.25209393 | 0.99510347 | −1.2582550 |
| X3 | −2.88266037 | 1.02399735 | −2.8151053 |

TABLE 75
RESULTS AT 7500 Hz

| | Value | Std. Error | t. value |
|---|---|---|---|
| 7500 Hz | | | |
| Insertion | | | |
| Effect | | | |
| X1 | −6.665475332 | 2.2928263 | −2.90709996 |
| X2 | −6.678922730 | 2.1301006 | −3.13549639 |
| X3 | −18.482033551 | 2.1919503 | −8.43177578 |
| Occlusion | | | |
| Effect | | | |
| X1 | −2.14003047 | 1.05586865 | −2.0267961 |
| X2 | −1.06587090 | 0.98093188 | −1.0865901 |
| X3 | −2.78648541 | 1.00941427 | −2.7604973 |

TABLE 76
RESULTS AT 7600 Hz

| | Value | Std. Error | t. value |
|---|---|---|---|
| 7600 Hz | | | |
| Insertion | | | |
| Effect | | | |
| X1 | −6.453321221 | 2.3169883 | −2.785219570 |
| X2 | −6.517903336 | 2.1525478 | −3.027994735 |
| X3 | −18.428207086 | 2.2150493 | −8.319547271 |
| Occlusion | | | |
| Effect | | | |
| X1 | −1.81049894 | 1.05228996 | −1.7205324 |
| X2 | −0.71468545 | 0.97760718 | −0.7310558 |
| X3 | −2.58402589 | 1.00599303 | −2.5686320 |

TABLE 77
RESULTS AT 7700 Hz

| | Value | Std. Error | t. value |
|---|---|---|---|
| 7700 Hz | | | |
| Insertion | | | |
| Effect | | | |
| X1 | −6.176510870 | 2.3478779 | −2.63067809 |
| X2 | −6.290253935 | 2.1812450 | −2.88379060 |
| X3 | −18.283821601 | 2.2445798 | −8.14576596 |
| Occlusion | | | |
| Effect | | | |
| X1 | −1.48510082 | 1.07347198 | −1.3834556 |
| X2 | −0.55147183 | 0.99728587 | −0.5529727 |
| X3 | −2.27496805 | 1.02624312 | −2.2167925 |

TABLE 78
RESULTS AT 7800 Hz

| | Value | Std. Error | t. value |
|---|---|---|---|
| 7800 Hz | | | |
| Insertion | | | |
| Effect | | | |
| X1 | −6.06108309 | 2.3716242 | −2.55566757 |
| X2 | −6.19084626 | 2.2033061 | −2.80979857 |
| X3 | −18.21570774 | 2.2672814 | −8.03416280 |
| Occlusion | | | |
| Effect | | | |
| X1 | −1.413226227 | 1.09382747 | −1.29200104 |
| X2 | −0.491633275 | 1.01619670 | −0.48379736 |
| X3 | −2.147169312 | 1.04570304 | −2.05332607 |

TABLE 79
RESULTS AT 7900 Hz

| | Value | Std. Error | t. value |
|---|---|---|---|
| 7900 Hz | | | |
| Insertion | | | |
| Effect | | | |
| X1 | −6.01019067 | 2.3741523 | −2.53151017 |
| X2 | −6.17081726 | 2.2056547 | −2.79772587 |
| X3 | −18.20382232 | 2.2696982 | −8.02037121 |
| Occlusion | | | |
| Effect | | | |
| X1 | −1.116427464 | 1.12532100 | −0.99209689 |
| X2 | −0.075233199 | 1.04545509 | −0.07196215 |
| X3 | −2.042620033 | 1.07581097 | −1.89867931 |

TABLE 80
RESULTS AT 8000 Hz

| | Value | Std. Error | t. value |
|---|---|---|---|
| 8000 Hz | | | |
| Insertion | | | |
| Effect | | | |
| X1 | −5.994943790 | 2.3595836 | −2.540678681 |
| X2 | −6.231208076 | 2.1921200 | −2.842548786 |
| X3 | −18.251784219 | 2.2557705 | −8.091152906 |
| Occlusion | | | |
| Effect | | | |
| X1 | −0.919289912 | 1.11313021 | −0.82586018 |
| X2 | 0.150751742 | 1.03412949 | 0.14577647 |
| X3 | −1.869693540 | 1.06415653 | −1.75697229 |

While exemplary embodiments have been shown and described, various modifications and substitutions may be made thereto without departing from the spirit and scope of the invention. Accordingly, it is to be understood that the present invention has been described by way of illustration and not limitation.

1. A hearing aid, comprising:
a receiver positioned within the ear canal of a user, the receiver generating no more than about three decibels of insertion loss over human ear audible frequencies.

2. The hearing aid according to claim 1, wherein the receiver generates no more than about two decibels of insertion loss over human ear audible frequencies.

3. The hearing aid according to claim 2, wherein the receiver generates no more than about one decibel of insertion loss over human ear audible frequencies.

4. The hearing aid according to claim 1, wherein the receiver generates no more than about three decibels of insertion loss over audible frequencies between about 2200 Hertz and about 5300 Hertz.

5. The hearing aid according to claim 4, wherein the receiver generates no more than about three decibels of insertion loss over audible frequencies between about 3000 Hertz and about 5000 Hertz.

6. The hearing aid according to claim 5, wherein the receiver generates no more than about three decibels of insertion loss over audible frequencies between about 3500 Hertz and about 4500 Hertz.

7. The hearing aid according to claim 1, wherein the receiver is positioned within the bony and/or cartilaginous region of the ear canal of the user.

8. The hearing aid according to claim 1, wherein the receiver has a maximum lateral dimension that is less than half the maximum lateral dimension of a user's ear canal.

9. The hearing aid according to claim 8, wherein the receiver has a maximum lateral dimension that is less than thirty percent of the maximum lateral dimension of a user's ear canal.

10. The hearing aid according to claim 9, wherein the receiver has a maximum lateral dimension that is less than twenty percent of the maximum lateral dimension of a user's ear canal.

11. The hearing aid according to claim 10, wherein the receiver has a maximum lateral dimension that is less than ten percent of the maximum lateral dimension of a user's ear canal.

12. The hearing aid according to claim 11, wherein the receiver has a maximum lateral dimension that is less than five percent of the maximum lateral dimension of a user's ear canal.

13. (canceled)

14. (canceled)

15. (canceled)

16. (canceled)

17. (canceled)

18. (canceled)

19. The hearing aid according to claim 1, further comprising a sound processing unit; and an intermediate connecting portion, wherein a retaining wire extends from at least one of the intermediate connecting portion and the receiver, and further wherein the retaining wire is configured to engage at least a portion of the concha of a user's ear.

20. (canceled)

21. The hearing aid according to claim 19, wherein the retaining wire is configured such that the receiver has a maximum insertion depth into an ear canal.

22. The hearing aid according to claim 19, wherein the retaining wire is configured such that the receiver does not substantially contact any portion of an ear canal when inserted within the ear canal.

23. The hearing aid according to claim 19, wherein the retaining wire stabilizes the receiver in the ear canal.

24. The hearing aid according to claim 19, wherein the retaining wire prevents any movement of the receiver in the ear canal.

25. (canceled)

26. The hearing aid according to claim 1, wherein the receiver comprises a speaker, at least partially enclosed within a casing having first and second end portions, the first end portion communicating with an intermediate connecting portion, the speaker communicating with a port provided at the second end portion of the casing.

27. The hearing aid according to claim 26, wherein the port is at least partially sealed to debris by a membrane or mesh material.

28. The hearing aid according to claim 27, wherein the casing is sealed to debris at the first end portion and along a length of the casing extending from the first end portion to the port.

29. The hearing aid according to claim 26, wherein the port includes a removable cerumen collector.

30. A hearing aid, comprising:
a receiver, configured to be positioned within the bony and/or cartilaginous region of a user's ear canal, the receiver dimensioned so as to minimize insertion loss upon positioning of the receiver within the bony and/or cartilaginous region.

31. The hearing aid according to claim 30, wherein the receiver generates no more than about three decibels of insertion loss over human ear audible frequencies between about 2200 Hertz and about 5300 Hertz.

32. The hearing aid according to claim 30, wherein the receiver has a maximum lateral dimension that is less than twenty percent of the maximum lateral dimension of a user's ear canal.

33. (canceled)

34. (canceled)

35. The hearing aid according to claim 30, further comprising a sound processing unit; and an intermediate connecting portion including at least two electrical conducting components provided within the intermediate connecting portion, wherein the at least two electrical conducting components are provided within at least two channels at least partially isolated from one another.

36. A hearing aid, comprising:
a receiver, configured to be positioned within a user's ear canal, the receiver having a maximum lateral dimension that is less than thirty percent of the maximum lateral dimension of a user's ear canal.

37. The hearing aid according to claim 36, wherein the receiver has a maximum lateral dimension that is less than twenty percent of the maximum lateral dimension of a user's ear canal.

38. The hearing aid according to claim 36, wherein the receiver has a maximum lateral dimension that is less than ten percent of the maximum lateral dimension of a user's ear canal.

39. A hearing aid, comprising: a receiver;
a sound processing unit; and
an intermediate connecting portion, wherein a retaining wire extends from at least one of the intermediate connecting portion and the receiver, and further wherein the retaining wire is configured to engage at least a portion of the concha of a user's ear.

40. A hearing aid, comprising:
a receiver;
a sound processing unit; and
an intermediate connecting portion, wherein the intermediate connecting portion comprises an electrical conducting component and a stiffening wire, provided on at least a portion of the intermediate connecting portion.

41. A hearing aid, comprising:
a receiver;
a sound processing unit; and
an intermediate connecting portion, including at least two electrical conducting components provided within the intermediate connecting portion, wherein the at least two electrical conducting components are provided within at least two channels at least partially isolated from one another.
